(19) United States
(12) Patent Application Publication
(10) Pub. No.: US 2011/0201549 A1
(43) Pub. Date: Aug. 18, 2011

(54) Enhancement of Bacillus Thuringiensis Cry Toxicities to Lesser Mealworm Alphitobius Diaperinus

(75) Inventor: Michael J. Adang, Athens, GA (US)

(73) Assignee: The University of Georgia Research Foundation, Inc, Athens, GA (US)

(21) Appl. No.: 13/056,380

(22) PCT Filed: Jul. 30, 2009
(86) PCT No.: PCT/US2009/052296

§ 371 Date: Apr. 25, 2011

Related U.S. Application Data
(60) Provisional application No. 61/084,952, filed on Jul. 30, 2008.
(60) Provisional application No. 61/153,886, filed on Feb. 19, 2009.

(30) Foreign Application Priority Data
Aug. 11, 2008 (US) 2008/072806

(51) Int. Cl. A01N 37/18; A01P 7/04

(52) U.S. Cl. 514/4.5

(57) ABSTRACT

The subject invention relates in part to the discovery that BtBooster (BtB) peptides enhance Bt strain and Cry protein toxicity to the lesser mealworm. The subject invention also relates in part to the discovery that Bt tenebrionis producing Cry3Aa crystals and Bt japonensis BuiBui producing Cry8Ca crystals are insecticidal to A. diperinus larvae (darkling beetle or lesser mealworm). The subject invention also relates in part to the discovery that fragments from cadherins of the western corn rootworm and the yellow mealworm enhance the toxicities of Bt tenebrionis and Bt japonensis BuiBui toxicity to coleopteran larvae of the genus Alphitobius. In addition, the subject invention relates in part to the use of cadherin fragments to enhance the toxicities of Cry3Aa, Cry3Bb and Cry8Ca to coleopteran larvae of the genus Alphitobius. The subject invention also relates in part to screening Bt strains and Cry proteins for toxicity to larvae of darkling beetles or lesser mealworm, Alphitobius diaperinus.

### BACKGROUND OF THE INVENTION

Beetle-active strains of Bacillus thuringiensis (Bt) strains usually express one or more of the following type of endotoxins: Cry1Ia, Cry3A, Cry3B, Cry8C, Cry8D, and Cry34Ab1/Cry35Ab1. Bt EG2158, a Cry3Aa producing strain, also produces Sip1A, a secreted protein with insecticidal activity against Colorado Potato Beetle (CPB), Southern Corn Rootworm (SCRW) and Western Corn Rootworm (WCRW) larvae (Donovan et al. 2006). The Cry3 class of Bt Cry proteins is known for toxicity to coleopteran larvae in the family Chrysomelidae. Cry3Aa and Cry3Bb proteins are highly toxic to Colorado potato beetle (CPB) Leptinotarsa decemlineata (Coleoptera: Chrysomelidae) and both were developed into Bt biopesticides and Bt crops. Due to limited efficacy of Cry3-based biopesticides and the success of competing chemical pesticides, these biopesticides have had limited usage and sales (Gelernter 2004). Cry3Aa also has activity against the elm leaf beetle Chrysomela scripta (Family Chrysomelidae) (Bauer 1990) and the yellow mealworm Tenebrio molitor (Family Tenebrionidae) (Herrnstadt et al. 1986).

Corn rootworms (CRW; Diabrotica species) are probably the most economically important corn insect pest. Adaptation of the CRW to crop rotation has reduced farmers' control options. Farmers' options to manage CRW include crop rotation, insecticide use, and (as of 2003) Bt seed technology (Payne et al. 2003). Cry3Bb is toxic to corn rootworms (Donovan et al. 1992; Johnson et al. 1993) and a modified version is expressed in commercialized MON863 corn hybrids (Vaughn et al. 2005). Other rootworm-protected Bt corn lines express Cry34Ab1/Cry35Ab1 (Dow AgroSciences) and modified Cry3A (Syngenta).

Bt Cry8 proteins for control of white grubs (Coleoptera: Scarabidae). Bt Cry8 proteins are known for their activities against white grubs which are important pests of turf. However, some Cry8 proteins are active against lepidopteran larvae. Currently 25 Cry8-type proteins are listed in the Bt toxin nomenclature database (http:/www.lifesci.sussex.ac.uk/home/Neil_Crickmore/bt/index.html. B. thuringiensis sub sp. japonensis strain Buibui produces Cry8Ca crystal protein which is active against Japanese beetles (Ohba et al. 1992) and other white grubs (Ohba et al. 1992; Sato et al. 1994; Alm et al. 1997). Ogiwara et al. reported the nucleotide sequence of the gene in Bt strain BuiBui encoding Cry8Ca of Bt (Ogiwara et al. 1995). The insecticidal protein produced by Bt var. japonensis strain N141 (also called strain BuiBui) and its insecticidal activity against lepidopterous and colepterous pests is claimed in U.S. Pat. Nos. 5,736,514, 5,834,296 and 5,837,526. See also U.S. Pat. No. 5,359,048.

Lesser mealworm (Alphitobius diaperinus, Coleoptera: Tenebrionidae) susceptibility to Bt strains. The lesser mealworm (larvae of litter beetle or darkling beetle), Alphitobius diaperinus is a serious pest in the poultry industry. Lesser mealworms, members of the tenebrionid family are commonly called darkling beetles as adults. Many tenebrionid larvae feed on stored grain and are called flour beetles or mealworms. With respect to susceptibility to Bt, the yellow mealworm Tenebrio molitor, a stored grain pest, is susceptible to the Cry3Aa toxin produced by Bt tenebrionis. The Tenebrionid Tribolium castaneum is not susceptible to Cry3Aa. A Bt strain called Bt PS43F reportedly has activity against Alphitobius (U.S. Pat. No. 5,064,648 Hickle et al. Nov. 12, 1991). The Bt PS43F strain, which is identical to PS86B1, produces a Cry3B protein. The Bt strain PS86B1 also reportedly has activity against Alphitobius (U.S. Pat. No. 5,100,665 to Hickle et al.). Bt kurstaki may have activity against larvae of this beetle (U.S. Pat. No. 5,244,660 O'brien et al. Sep. 14, 1993).

Litter beetles and a few other coleopteran species act as vectors for protozoan, bacterial, and viral diseases of chickens and turkeys resulting in significant economic loss. Approximately nine billion broilers are produced annually in the United States and global chicken production is increasing rapidly. Litter beetles act as a significant reservoir for pathogenic Salmonella species including the more pathogenic varieties, such as S. enterica serotype enteritidis (McAllister et al. 1994; Bates et al. 2004; Skov et al. 2004). The problem is that poultry contaminated with pathogenic organisms like Salmonella threaten human health. These beetles inhabit the litter, wood, Styrofoam, fiberglass, and polystyrene insulation panels of chicken houses. Larvae and adult beetles thrive both on bird droppings and on grains used as chicken feed and can reach incredibly high numbers, exceeding 2×10⁶ per 20,000 sq ft broiler house. These large beetle populations and their diverse habitats within chicken houses make it more difficult to eradicate the Salmonella they carry. In the midst of a heavy litter beetle infestation, or prior to establishing new chicken populations neither frequent changes in the litter nor dusting with multiple chemical insecticides is a completely effective control for the beetle (Miller 1990; Salin et al. 2003; Calibeo-Hayes et al. 2005). Thus, because litter beetles are endemic to chicken houses, they constitute a significant reservoir for pathogenic Salmonella and other pathogens, and this insect must be considered in any system of bacterial control.

Mode of coleopteran Cry toxin action relative to action of the lepidopteran-active Cry toxins. Cry3 toxins have a mode-of-action that is similar yet distinct from the action of lepidopteran-active Cry1 toxins. The Cry3A protoxin (73-kDa) lacks the large C-terminal region of the 130-kDa Cry1 protoxins, which is removed by proteases during activation to toxin. Cry3A protoxin is activated to a 55-kDa toxin and then further cleaved within the toxin molecule (Carroll et al. 1997; Loseva et al. 2002). Activated Cry3A toxin binds to brush border membrane vesicles (BBMV) with a Kd ˜37 nM (Martinez-Ramirez et al. 1996) and recognizes a 144-kDa binding protein in BBMV prepared from the yellow mealworm Tenebrio molitor (Coleoptera: Tenebrionidae) (Belfiore et al. 1994). Ochoa-Campuzano et al. (Ochoa-Campuzano et al. 2007) identified an ADAM metalloprotease as a receptor for Cry3Aa toxin in CPB larvae. Of particular relevance is the report of Fabrick et al. (Fabrick et al. 2009) identifying a novel cadherin in T. molitor as a functional receptor for Cry3Aa toxin.

Structural analyses of Cry3Aa revealed a three-domain structure (Li et al. 1991) that is similar to the Cry3Bb structure. Loop residues of domain 2 are involved in receptor binding (Wu et al. 1996). A triple mutant of Cry3Aa loop 1 was about 10-fold more toxic to T. molitor than wild-type Cry3Aa (Wu et al. 2000). Structural differences between Cry3Bb and Cry3Aa toxins must underlie the unique rootworm activities of Cry3Bb toxin. As noted by Galitsky et al. (Galitsky et al. 2001), differences in toxin solubility, oligomerization, and binding are reported for the Cry3 toxins. Recently, Cry3Aa was modified to have activity against western corn rootworm (WCRW) Diabrotica virgifera virgifera (Coleoptera: Chrysomelidae) (Walters et al. 2008). Those authors introduced a chymotrypsin/cathepsin G site into domain 1 of Cry3Aa that allowed processing of the 65-kDa form to a 55-kDa toxin that bound rootworm midgut.

Selection and modification of insect cadherin fragments for enhanced insect control with Bt Cry1 toxins. Cadherins localized in the midgut epithelium function as receptors for Cry toxins in lepidopteran, dipteran and coleopteran larvae. An important Cry1 toxin binding site is localized within the final cadherin repeat (CR) 12 of cadherins from tobacco hornworm Manduca sexta (Lepidoptera: Sphingidae) and tobacco budworm Heliothis virescens (Lepidoptera: Noctuidae) (Hua et al. 2004; Xie et al. 2005). Unexpectedly, a fragment of Bt-R₁ cadherin, the Cry1A receptor from M. sexta, not only bound toxin but enhanced Cry1A toxicity against lepidopteran larvae (Chen et al. 2007).

Cry1Ab toxin binds MsCad-CR12-MPED at high affinity (Kd=9 nm) and low affinity (Kd=1 μM) sites. High affinity binding correlates with synergism as deletion of the high-affinity binding site greatly reduced enhancement of Cry1Ab to M. sexta (Chen et al. 2007). Surprisingly, MsCad-CR12-MPED also binds brush border membrane vesicles with high affinity (Kd=32 nM). In Chen et al. (Chen et al. 2007) we explained the observed synergism as due to the binding of MsCad-CR12-MPED to toxin and microvilli as a means to increase the probability of toxin interacting with receptors. Soberon et al. (Soberon et al. 2007) reported that MsCad-CR12-MPED binding to Cry1Ab induces a conformational change that allows cleavage of toxin in domain 1 by a protease resulting in formation of a toxin oligomeric pre-pore structure.

The M. sexta cadherin BtR1 has at least three Cry1Ab binding sites Some related results were recently published (Abdullah et al. 2009). For example, various lengths of Bt-R₁ were expressed in Escherichia coli as inclusion bodies and mixed with trypsin-activated Cry1Ac at a fixed toxin to cadherin mass ratio and tested in diet-overlay bioassays against Helicoverpa zea larvae. The LCₛₒ for Cry1Ac alone was estimated to be 1.9 (1.3-3.3) μg/cm². The LC₅₀ of Cry1Ac in the presence of the ‘original’ MsCad-CR12-MPED fragment was 0.61 (0.48-0.93) for a synergism factor of 3.1-fold. Peptides with more contiguous CR units had increased Cry1Ac induced mortality. MsCad-CR10-12 and MsCad-CR7-12 reduced LC₅₀ values 95- and 112-fold, respectively.

DvCad1-CR8-10 peptide of Diabrotica virgifera virgifera (West Corn Rootworm) midgut cadherin, but not mosquito cadherin peptides enhance Cry3Aa toxicity to Colorado potato beetle larvae and corn rootworms. The DvCad1-CR8-10 peptide of D. virgifera virgifera midgut cadherin (Sayed et al. 2007b), but not mosquito cadherin peptides, enhances Cry3Aa toxicity to Colorado potato beetle larvae and corn rootworms. Park et al. (Park et al. 2009) reported that a contiguous last three CR fragment from the cadherin of the western corn rootworm (WCRW) (D. virgifera virgifera) binds Cry3 toxins and enhances toxicity to larvae of Colorado potato beetle (CPB) and corn rootworms. The cadherin fragment (DvCad1-CR8-10) of western corn rootworm was expressed in E. coli as an inclusion body. WCRW larvae were fed diet treated with Cry3Bb crystals alone or crystals with DvCad1-CR8-10 inclusions. The addition of a 1:10 mass ratio of Cry3Bb:DvCad1-CR-8-10) reduced the Cry3Bb LC₅₀ values 13.1-fold. The maximal enhancement of Cry3Bb toxicity occurred at 1:10 Cry3Bb-CR8-10 mass ratio. By an ELISA microplate assay we demonstrated the CR8-10 peptide binds chymotrypsin-treated Cry3Ba toxins at high affinity (1.8 nM).

### BRIEF SUMMARY OF THE INVENTION

The subject invention relates in part to the use of BtBooster (BtB) peptides that enhance Bt strain and Cry protein toxicity to the lesser mealworm.

The subject invention relates in part to the discovery that Bt tenebrionis producing Cry3Aa crystals and Bt japonensis BuiBui producing Cry8Ca crystals are insecticidal to A. diperinus larvae (darkling beetle or lesser mealworm).

The subject invention also relates in part to the discovery that fragments from cadherins of the western corn rootworm and the yellow mealworm enhance the toxicities of Bt tenebrionis (a strain producing Cry3Aa crystals) and Bt japonensis BuiBui (a strain producing Cry8Ca crystals) toxicity to coleopteran larvae of the genus Alphitobius.

The subject invention also relates in part to the use of cadherin fragments to enhance the toxicities of Cry3Aa, Cry3Bb and Cry8Ca to coleopteran larvae of the genus Alphitobius. Such toxicity-enhancing cadherin fragments are referred to herein as Bt Boosters (BtBs).

The subject invention also relates in part to screening Bt strains and Cry proteins for toxicity to such pests, particularly larvae of darkling beetles or lesser mealworm, Alphitobius diaperinus.

### BRIEF DESCRIPTION OF THE FIGURES

FIG. 1 illustrates wild-type insect cadherin and cadherin fragments (i.e. peptides) with synergistic activities, including: cadherin fragments DvCad1-CR8-10 from Diabrotica virgifera virgifera (Western corn rootworm, WCRW), referred to as BtB7, and the fragment of T. molitor cadherin called TmCad1-TBR for T. molitor cadherin Toxin Binding Region. This same fragment corresponds to the CR12-MPED peptide of TmCad1 (Fabrick et al. 2009).

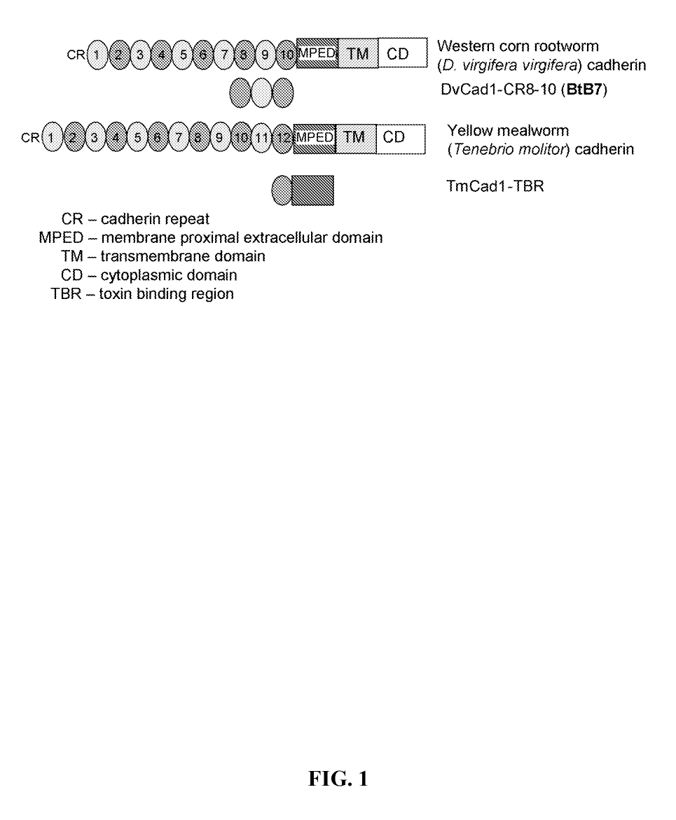

FIG. 2 illustrates the toxicity of a Bt tenebrionis (Btt) spore+Cry3Aa crystal preparation to lesser mealworm, A. diaperinus, and enhancement of toxicity by the cadherin peptide BtB7. Panel A shows the enhancement effects of increasing ratios of BtB7 peptide inclusions added to a Btt preparation. The Btt spore+suspension was in diluent alone or mixed with BtB7 cadherin peptide inclusion bodies in the indicated Btt:BtB7 mass ratios. Suspensions were applied to semi-solid chicken feed diet. Different letters above the error bars indicates a significant difference between the means (P, 0.001). In Panel B, the Btt:BtB7 mass ratio was maintained at 1:100 mass based on calculated amounts of Cry3Aa and BtB7 protein in the respective preparations. Mortality was scored on day 3. Control mortality (%) was 3.12±3.12 for Panel A. Sample size was 1 larva/well and 16 wells per treatment. Bioassays were repeated two times for each treatment.

FIG. 3 illustrates the toxicity of a Bt japonensis BuiBui spore+Cry8Ca crystal preparation to the lesser mealworm and enhancement of toxicity by the cadherin peptide BtB7. Panel A shows the enhancement effects of increasing ratios of BtB7 peptide inclusions added to a Bt BuiBui preparation. The Bt BuiBui suspension was mixed in diluent alone or with BtB7 inclusion bodies in the indicated Bt buibui:BtB7 mass ratios. Different letters above the error bars indicates a significant difference between the means (P, 0.001). In Panel B, the ratio of Bt BuiBui:BtB7 was maintained at a 1:100 mass ratio based on calculated amounts of Cry8Ca and BtB7 in the respective preparations. Mortality was scored on day 3. Sample size was 1 larva/well and 16 wells per treatment. Bioassays were repeated two times for each treatment.

FIG. 4 illustrates the toxicity of Cry3Aa crystals to lesser mealworm and enhancement of Cry3Aa toxicity by BtB7 cadherin peptide inclusion bodies. Panel A shows a dose response curve of Cry3Aa crystal toxicity to lesser mealworms. Panel B shows increased Cry3Aa toxicity to lesser mealworms with the addition of increasing mass ratios of Cry3Aa:BtB7 peptide inclusion bodies.

FIG. 5 illustrates the toxicity of Cry3Bb crystals to lesser mealworm and enhancement of Cry3Bb toxicity by BtB7 cadherin peptide inclusion bodies. Panel A shows a dose response curve of Cry3Bb crystal toxicity to larvae. Panel B shows increased Cry3Bb toxicity to lesser mealworms with the addition of increasing mass ratios of Cry3Bb:BtB7 peptide inclusion bodies.

FIG. 6 illustrates the toxicity of Cry8Ca crystals to lesser mealworm and enhancement of Cry8Ca toxicity by BtB7 cadherin peptide inclusion bodies. Panel A shows a dose response curve of Cry8Ca crystal toxicity to larvae. Panel B shows increased Cry8Ca toxicity to lesser mealworms with the addition of a 1:10 mass ratio of Cry8Ca:BtB7 peptide inclusion bodies.

FIG. 7 illustrates TmCad1-TBR binding to Cry3Bb (Panel A) and enhancement of Cry3Bb toxicity to lesser mealworm by TmCad1-TBR peptides (Panel B). In Panel A, TmCad1-TBR binding to Cry3Bb protein was determined using an ELISA-based binding assay. Microtiter plates were coated with chymotrypsin-treated Cry3Bb and then incubated with increasing various concentrations of biotinylated TmCad1-TBR peptide. Bound biotinylated TmCad1-TBR peptide was detected with a Streptavidin-HRP conjugate and substrate. Non-specific binding was determined in the presence of 1000-fold excess unlabeled TmCad1-TBR peptide. Each data point is the mean of two experiments done in duplicate. Error bars depict standard deviation. Binding affinities (Kd) were calculated based on specifically bound biotinylated TmCad1-TBR peptide using a one site saturation binding equation. Panel B shows the enhancement of increasing ratios of TmCad1-TBR peptide in Cry3Bb suspensions. Cry3Bb inclusions without or with and increased amount of TmCad1-TBR inclusions were applied to semi-solid diet. One 1^{st} instar darkling beetle larva was applied per well and the bioassays was scored on day 3. No toxicity was observed when treated with TmCad1-TBR peptide alone.

### BRIEF DESCRIPTION OF THE SEQUENCES

SEQ ID NOs:1 and 2 provide the polynucleotide and amino acid sequences of DvCad1-CR8-10 nucleotide and amino acid sequence from the WCRW cadherin. The polypeptide/protein of SEQ ID NO:2 is also known as BtB7.

SEQ ID NOs:3 and 4 provide the polynucleotide and amino acid sequences of the TmCad1-TBR cadherin fragment from the Tenebrio molitor cadherin. The coding region includes the last cadherin repeat (CR) and membrane proximal extracellular domain (MPED) of the Tenebrio molitor cadherin. (This sequence corresponds to CR12-MPED of TmCad1 (Fabrick et al. 2009).) The 5′ and 3′ ends contain Nde1 and Xho1 sites for cloning into an E. coli expression vector. A 6×His coding sequence was included at the C-terminus. This region was cloned into pET30a and expressed in E. coli.

### DETAILED DISCLOSURE OF THE INVENTION

The subject invention relates in part to the discovery that Bt tenebrionis producing Cry3Aa crystals and Bt japonensis BuiBui producing Cry8Ca crystals are insecticidal to A. diperinus larvae (darkling beetle, lesser mealworm). The subject invention also relates in part that a fragment of western corn rootworm (WCRW) cadherin and a fragment of yellow mealworm cadherin enhance Bt tenebrionis and Bt japonensis BuiBui toxicities to coleopteran larvae, particularly those in the family Tenbrionidae and genus Alphitobius. The subject invention also relates in part that the same coleopteran cadherin fragments enhance Cry3Aa, Cry3Bb and Cry8Ca toxicities to larvae of Alphitobius diaperinus.

The western corn rootworm midgut cadherin (Sayed et al. 2007a) was used as a template to design a cadherin fragment that includes a potential toxin binding site. The designed CR8-10 peptide, called DvCad-CR8-10 includes the predicted binding site ¹³¹¹SSLNVTVN¹³¹⁸ which has similarity to Cry1A toxin binding region 2 (TBR 2) of M. sexta cadherin (Sayed et al. 2007a). The WCRW cadherin and the Dv-Cad-CR8-10 cadherin peptide do not contain a clear match to TBR 3 (GVLTLNIQ; residues 1416-1423) of M. sexta cadherin (Chen et al. 2007). This is significant because when Chen et al. (Chen et al. 2007) deleted the critical TBR 3, their cadherin fragment did not bind or enhance Cry1A toxicity. Three cadherin repeats were included in our cadherin peptide, in part because of observations that CR10-12 of M. sexta cadherin has greater Cry1A toxin binding and enhancing properties than CR12 alone.

The CR8-10 cadherin fragment from WCRW increased the potencies of Bt tenebrionis and Bt japonensis BuiBui against A. diaperinus larvae an estimated four and eight-fold. This level of potentiation is comparable and in some cases greater than our published reports of cadherin fragment enhancement of Cry1Ab toxicity to M. sexta and Cry4Ba toxicity to A. gambiae (Chen et al. 2007; Hua et al. 2008). The CR8-10 cadherin fragment from WCRW also increased the toxicities of Cry3Aa, Cry3Bb and Cry8Ca to A. diaperinus larvae. A fragment of T. molitor cadherin containing a Cry3Bb toxin binding region had the ability to enhance Cry3Bb toxicity to A. diaperinus larvae.

A. diaperinus (larvae) is an important pest of poultry production that has the ability to transmit disease-causing organisms such as Salmonella to humans. Adults of this insect species also cause structural damage to poultry houses. Control of A. diaperinus is often inadequate; due in part to insect resistance to chemical pesticides. There is a long-felt, and long-not-satisfied need for biopesticides such as Bt for the control of A. diaperinus.

Based on current data disclosed herein, the exemplified and other BtBs could enhance other (coleopteran-active) Bt Cry toxins (see e.g. the online Bt specificity database: world wide web glfc.forestry.ca/bacillus/). See also Crickmore et al. (world wide web website lifesci.sussex.ac.uk/home/Neil_Crickmore/Bt/) for a list of Bt toxins.

The subject polypeptides and protein toxins can be “applied” or provided to contact the target insects in a variety of ways. For example, transgenic plants (wherein the protein is produced by and present in the plant) can be used and are well-known in the art. Expression of the toxin genes can also be achieved selectively in specific tissues of the plants, such as the roots, leaves, etc. This can be accomplished via the use of tissue-specific promoters, for example. Spray-on applications are another example and are also known in the art. The subject polypeptides/proteins can be appropriately formulated for the desired end use, and then sprayed (or otherwise applied) onto the plant and/or around the plant/to the vicinity of the plant to be protected—before an infestation is discovered, after target insects are discovered, both before and after, and the like. Bait granules, for example, can also be used and are known in the art. Various combinations of approaches are discussed in WO 2005/070214 A2, US-2005-0283857-A1, and U.S. Pat. No. 7,396,813.

The subject proteins and polypeptides can be produced in practically any type of plant. Examples of such plants include maize, sunflower, soybean, cotton, canola, rice, sorghum, wheat, barley, vegetables, ornamentals, peppers (including hot peppers), sugar beets, fruit, and turf, to name but a few.

As one skilled in the art will appreciate in light of the subject disclosure, formulations for delivering Bt biopesticides can be adapted for use according to the subject invention. The performance of Bt biopesticides relies in part on the ingestion of the crystals by insect larvae. Therefore, different types of Bt formulations are used to control insects in different habitats. Common formulations are granular and flowable. Bt formulations may also be used with bait or feeding stimulants to attract the target insects and induce feeding. For control of lesser mealworm in poultry houses, the Bt formulation could be applied directly to infested poultry manure or litter.

There has also been development of non-viable recombinant organisms that could increase persistence in the environment, such as products based on encapsulated Bt toxins in Pseudomonas fluorescens. This approach ameliorates concerns associated with releasing live genetically engineered microorganisms into the environment.

In some preferred embodiments, the subject peptides are fed to target insects together with one or more insecticidal proteins, preferably (but not limited to) B.t. Cry proteins. When used in this manner, the peptide fragment can not only enhance the apparent toxin activity of the Cry protein against the insect species that was the source of the receptor but also against other insect species.

Methods of the subject invention can be used to inhibit lesser meal worm insects (including their larvae). Complete kill of the target insect does not have to be achieved, but inhibition can be severe enough to, for example, sicken the insects and prevent the target insects from propagating—thereby reducing or eliminating the spread of disease and/or infection, for example.

A related aspect of the inventions pertains to the use of an isolated polynucleotide that encodes a protein comprising (or consisting of) a fragment of a cadherin-like protein. The subject invention includes a cell (and use thereof) carrying the polynucleotide and expressing the peptide fragment, including methods of feeding the peptide (preferably with B.t. Cry toxins) to insects.

The nucleotide sequences can be used to transform bacterial hosts for the purpose of producing the cadherin fragments. Such bacterial hosts may include Bacillus thuringiensis, Eschericia coli and Pseudomonas fluorescens. In some embodiments the cells would be lysed and the cadherin protein extracted or the lysate may be used, preferably with Bt Cry proteins, for insect control. In some embodiments, the cadherin fragment expressed in bacterial cells would be used without killing or lysing the cells. Microorganisms other than bacteria could be used in this manner.

The nucleotide sequences can be used to transform hosts, such as plants, to express the receptor fragments (preferably cadherin fragments) of the subject invention. Transformation of plants with the genetic constructs disclosed herein can be accomplished using techniques well known to those skilled in the art. Thus, in some embodiments, the subject invention provides nucleotide sequences that encode fragments of receptors, preferably DvCad1, or TmCad1 cadherin-like proteins. Production of the cadherin protein in leaves or stems could utilize constitutive promoters such as the 35S promoter or T-DNA promoters which are well-known in the art.

Alternatively, promoters could be selected that direct expression of the cadherin fragment to the seed. The napin promoter (napA) of Brassica napus is an example of an endosperm-specific promoter of this type (Ellerstrom et al. 1996. Plant Molec. Biol. 32:1019-1027. Protein production in cereal grains such as rice or barley is also a means to produce large amounts of the cadherin fragment for insect control. The globulin promoter of rice is suitable for high level protein production in rice (Hwang et al. 2002. Plant Cell Rep. 20: 842-847). Plants and/or plant parts containing the expressed cadherin fragment (and Cry protein if desired) could be ground into meal. Such BTB plant powder could also be mixed with Bt Cry proteins and delivered to the habitat of the pest larvae for insect control. Seeds of plants containing the expressed cadherin fragment could be ground into plant flour, mixed with Bt Cry proteins if desired, and delivered to the habitat of the pest larvae for insect control.

Cadherin fragments could be co-expressed in plants alone or with one or more Bt Cry proteins. Additionally, more than one type of cadherin fragment could be selected for co-expression in plants.

The receptor used as the source of this domain(s), for use against coleopterans, can be derived from various pests and insects, particularly coleopterans such as Diabrotica species and mealworms such as Tenebrio molitor and Alphitobius diaperinus. However, fragments of the subject invention could also be derived from midgut, Cry-binding cadherins from non-coleopteran insects, such as Manduca sexta larvae. Many sequences of such receptors are publicly available.

Because of the unique and novel approach of the subject invention, the subject invention can be used to enhance and expand the spectrum (or insect range) of toxicity of a given insect-toxic protein. In some preferred embodiments, these peptide fragments can be used to enhance the potency of Bt toxins for controlling insects. In some preferred embodiments, the peptide fragments enhance the toxicity of Cry1 toxins, but as shown herein, the subject invention is not limited to use with such toxins.

Based on the subject disclosure, one skilled in the art can practice various aspects of the subject invention in a variety of ways. For example, the fragment of cadherin-like protein may be expressed as a fusion protein with a Bt Cry toxin using techniques well known to those skilled in the art. As described herein, preferred fusions would be chimeric toxins produced by combining a toxin (including a fragment of a protoxin, for example) and a fragment of a cadherin-like protein. In addition, mixtures and/or combinations of toxins and cadherin-like protein fragments can be used according to the subject invention. These mixtures or chimeric proteins have the unexpected and remarkable properties of enhanced insecticidal potency to coleopteran larvae.

In light of and having the benefit of the subject application, variants of novel BtBs of the subject invention (e.g. those derived from Diabrotica and Tenebrio cadherins) can be constructed using techniques that are known in the art.

It will be recognized by those skilled in the art that the DNA sequences may vary due to the degeneracy of the genetic code and codon usage. All DNA sequences which code for exemplified and/or suggested peptides (and proteins) are included. The subject invention also includes polynucleotides having codons that are optimized for expression in plants, including any of the specific types of plants referred to herein. Various techniques for creating plant-optimized sequences are known in the art.

Additionally, it will be recognized by those skilled in the art that allelic variations may occur in the DNA sequences which will not significantly change activity of the amino acid sequences of the peptides which the DNA sequences encode. All such equivalent DNA sequences are included within the scope of this invention and the definition of the regulated promoter region. The skilled artisan will understand that exemplified sequences can be used to identify and isolate additional, non-exemplified nucleotide sequences that will encode functional equivalents to the DNA sequences, including those that encode amino acid sequences having at least 85% identity thereto and having equivalent biological activity, those having at least 90% identity, and those having at least 95% identity to a novel BtB polypeptide of the subject invention. Other numeric ranges for variant polynucleotides and amino acid sequences are provided below (e.g., 50-99%). Following the teachings herein and using knowledge and techniques well known in the art, the skilled worker will be able to make a large number of operative embodiments having equivalent DNA sequences to those listed herein without the expense of undue experimentation.

As used herein percent sequence identity of two nucleic acids is determined using the algorithm of (Karlin et al. 1990), modified as in (Karlin et al. 1993). Such an algorithm is incorporated into the NBLAST and XBLAST programs of (Altschul et al. 1990). BLAST nucleotide searches are performed with the NBLAST program, score=100, wordlength=12, to obtain nucleotide sequences with the desired percent sequence identity. To obtain gapped alignments for comparison purposes, Gapped BLAST is used as described in (Altschul et al. 1997). When utilizing BLAST and Gapped BLAST programs, the default parameters of the respective programs (NBLAST and XBLAST) are used. See ncbi.nih.gov website.

Polynucleotides (and the peptides and proteins they encode) can also be defined by their hybridization characteristics (their ability to hybridize to a given probe, such as the complement of a DNA sequence exemplified herein). Various degrees of stringency of hybridization can be employed. The more stringent the conditions, the greater the complementarity that is required for duplex formation. Stringency can be controlled by temperature, probe concentration, probe length, ionic strength, time, and the like. Preferably, hybridization is conducted under moderate to high stringency conditions by techniques well known in the art, as described, for example, in (Keller et al. 1987) Keller, G. H., M. M. Manak (1987) DNA Probes, Stockton Press, New York, N.Y., pp. 169-170.

As used herein “moderate to high stringency” conditions for hybridization refers to conditions that achieve the same, or about the same, degree of specificity of hybridization as the conditions “as described herein.” Examples of moderate to high stringency conditions are provided herein. Specifically, hybridization of immobilized DNA on Southern blots with ³²P-labeled gene-specific probes was performed using standard methods (Sambrook et al. 2001). In general, hybridization and subsequent washes were carried out under moderate to high stringency conditions that allowed for detection of target sequences with homology to sequences exemplified herein. For double-stranded DNA gene probes, hybridization was carried out overnight at 20-25° C. below the melting temperature (Tm) of the DNA hybrid in 6×SSPE, 5×Denhardt's solution, 0.1% SDS, 0.1 mg/ml denatured DNA. The melting temperature is described by the following formula from (Beltz et al. 1983).

Tm=81.5° C.+16.6 Log [Na+]+0.41(% G+C)−0.61 (% formamide) 600/length of duplex in base pairs.

Washes are typically carried out as follows:
(1) Twice at room temperature for 15 minutes in 1×SSPE, 0.1% SDS (low stringency wash).
(2) Once at Tm-20° C. for 15 minutes in 0.2×SSPE, 0.1% SDS (moderate stringency wash).

For oligonucleotide probes, hybridization was carried out overnight at 10-20° C. below the melting temperature (Tm) of the hybrid in 6×SSPE, 5×Denhardt's solution, 0.1% SDS, 0.1 mg/ml denatured DNA. Tm for oligonucleotide probes was determined by the following formula from Suggs et al. (1981):

Tm(° C.)=2(number T/A base pairs)+4(number G/C base pairs)

Washes were typically carried out as follows:
(1) Twice at room temperature for 15 minutes 1×SSPE, 0.1% SDS (low stringency wash).
(2) Once at the hybridization temperature for 15 minutes in 1×SSPE, 0.1% SDS (moderate stringency wash)

In general, salt and/or temperature can be altered to change stringency. With a labeled DNA fragment of greater than about 70 or so bases in length, the following can be used:

1 or 2×SSPE, room temperature

1 or 2×SSPE, 42° C.

0.2× or 1×SSPE, 65° C.

0.1×SSPE, 65° C.

Duplex formation and stability depend on substantial complementarity between the two strands of a hybrid, and, as noted above, a certain degree of mismatch can be tolerated. Therefore, polynucleotide sequences of the subject invention include mutations (both single and multiple), deletions, and insertions in the described sequences, and combinations thereof, wherein said mutations, insertions, and deletions permit formation of stable hybrids with a target polynucleotide of interest. Mutations, insertions, and deletions can be produced in a given polynucleotide sequence using standard methods known in the art. Other methods may become known in the future.

The mutational, insertional, and deletional variants of the polynucleotide and amino acid sequences of the invention can be used in the same manner as the exemplified sequences so long as the variants have substantial sequence similarity with the original sequence. As used herein, substantial sequence similarity refers to the extent of nucleotide similarity that is sufficient to enable the variant polynucleotide to function in the same capacity as the original sequence. Preferably, this similarity is greater than 50%; more preferably, this similarity is greater than 75%; and most preferably, this similarity is greater than 90%. The degree of similarity needed for the variant to function in its intended capacity will depend upon the intended use of the sequence. It is well within the skill of a person trained in this art to make mutational, insertional, and deletional mutations that are designed to improve the function of the sequence or otherwise provide a methodological advantage. In some embodiments, the identity and/or similarity can also be 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99% as compared to a sequence exemplified herein.

The amino acid identity/similarity and/or homology will be highest in critical regions of the protein that account for biological activity and/or are involved in the determination of three-dimensional configuration that ultimately is responsible for the biological activity. In this regard, certain amino acid substitutions are acceptable and can be expected if these substitutions are in regions that are not critical to activity or are conservative amino acid substitutions which do not affect the three-dimensional configuration of the molecule. For example, amino acids may be placed in the following classes: non-polar, uncharged polar, basic, and acidic. Conservative substitutions whereby an amino acid of one class is replaced with another amino acid of the same type fall within the scope of the subject invention so long as the substitution does not materially alter the biological activity of the compound. The following table provides a listing of examples of amino acids belonging to each class.

| Class of Amino Acid | Examples of Amino Acids |
|---|---|
| Nonpolar | Ala, Val, Leu, Ile, Pro, Met, Phe, Trp |
| Uncharged Polar | Gly, Ser, Thr, Cys, Tyr, Asn, Gln |
| Acidic | Asp, Glu |
| Basic | Lys, Arg, His |

In some instances, non-conservative substitutions can also be made.

All patents, patent applications, provisional applications, and publications referred to or cited herein are incorporated by reference in their entirety to the extent they are not inconsistent with the explicit teachings of this specification. Unless specifically indicated or implied, the terms “a”, “an”, and “the” signify “at least one” as used herein. Following are examples that illustrate procedures for practicing the invention. These examples should not be construed as limiting. All percentages are by weight and all solvent mixture proportions are by volume unless otherwise noted.

### Example 1

### Darkling Beetle Culture and Larval Bioassays

A. diaperinus adults were collected from poultry houses in Georgia and used to establish a colony. Darkling beetle adults and larvae were maintained in plastic containers with lids on a diet of cracked corn:wheat bran (95:5). The stack of plastic containers containing beetles and mealworms and diet were covered with a dark plastic trash bag and kept in a room having 14 hour light/10 hour dark photophase, 27° C. and 60-70% RH. For larval bioassays molten southern corn rootworm diet (Bioserv, Frenchtown, N.J.) was mixed in equal amounts with molten chicken feed diet (14.5 g agar, 144 g ground and sifted chicken feed pellets, 860 ml deionized water) and aliquoted into 128-well bioassay trays, (C-D International, Pittman, N.J.). Bt spore-crystal or Bt crystal preparations were tested alone in diluent or mixed with cadherin inclusions in diet surface bioassays. The materials were mixed and serially diluted with sterile deionized water and then overlaid onto the diet surface and dried. One 2-day old larva was transferred into each well, the trays were sealed with perforated lids (C-D International, Pitman, N.J.) and then covered with brown paper to provide a dark environment. Each bioassay was conducted with 16 larvae per replicate and two replicates per concentration.

### Example 2

### Culture of Bt Strains and Insect Bioassay

Bt strains were grown in peptone glucose salts medium (Brownbridge et al. 1986) until sporulation and cell lysis. Spore-crystal mixtures were harvested by centrifugation, washed with sterile deionized water and stored as a suspension at 5° C. The final Cry protein concentration in each preparation was determined by band density on 15% SDS-PAGE using bovine serum albumin as standard. Bt tenebrionis (containing Cry3Aa), Bt japonensis BuiBui (containing Cry8Ca) and two Bt strains (NRRL B-18298 and B-18299) described in U.S. Pat. No. 5,100,665 were produced by this method and tested in bioassays for toxicity to lesser mealworms. Each of these Bt strains was insecticidal to various levels when fed to larvae. Bt strain HD73 that produces Cry1Ac (a Lepidoptera-active toxin) was also produced by this method and tested in larval bioassays. Bt HD73 showed no toxicity to the litter beetle, suggesting the specificity of Bt activity for this insect.

### Example 3

### Purification of Cry3Aa Crystals from Bt tenebrionis

The Bt tenebrionis spore crystal mixture was harvested by centrifugation, suspended in 0.1M NaCl, 2% Triton X-100, 20 mM Bis-Tris, pH6.5 and sonicated. Spores and crystals were pelleted by centrifugation at 12,000 g for 10 min, washed twice with 0.5M NaCl, followed by a single wash in distilled water. Cry3Aa crystals were purified according to (Slaney et al. 1992) and the final Cry3Aa protein concentration was determined based on band density on SDS-15% PAGE, using BSA as standard. Crystals were stored at 4° C. until used for experimentation including performing bioassays on 2-day old A. diaperinus.

### Example 4

### Cloning and Expression of the DvCad1-CR8-10 of the Western Corn Rootworm Cadherin-Like Protein

A DNA fragment encoding amino acids 961-1329 (corresponding to CR8-10 sequence) of the D. virgifera virgifera cadherin-like protein (GI:156144975) was synthesized by GenScript Corp. (Piscataway, N.J.) and the synthetic gene was inserted between the Nde I and HindIII restriction enzyme sites of an expression vector, pET30a(+) (Novagen, Madison, Wis.). The coding sequence and clone orientation were confirmed by sequencing (Molecular Genetics Instrumentation Facility at University of Georgia). The pET construct was transformed into E. coli strain BL21(DE3)/pRIL (Stratagene, La Jolla, Calif.), and positive clones were selected on LB plates containing kanamycin and chloramphenicol. The DvCad1-CR8-10 peptide was overexpressed in E. coli as inclusion bodies. The expression and purification protocol for the truncated cadherin fragment was as described in a previous paper (Chen et al. 2007). The inclusion body form was prepared as a suspension in sterile deionized water. Total protein was measured by Bio-Rad protein assay using bovine serum albumin (BSA) as standard (Bradford 1976). One microgram of the cadherin peptide was analyzed by sodium dodecyl sulfate −15% polyacrylamide gel electrophoresis (SDS-15% PAGE) with Coomassie brilliant blue R-250 staining. Specific concentration of cadherin peptide in total protein was determined from Coomassie-stained gel by gel image analyzer (Alpha Innotech, San Leandro, Calif.) using BSA as standard.

### Example 5

### Cloning and Expression of the Tenebrio molitor Cadherin Toxin-Binding Region (TmCAD1-TBR)

Fabrick et al. (Fabrick et al. 2009) identified a novel cadherin called TmCad1 in midgut of T. molitor (yellow mealworm) as a receptor for Cry3Aa toxin. Those authors cloned the T. molitor cadherin starting with a partial T. molitor cDNA and modeled the protein for cadherin repeat regions using the ISREC ProfileScan Server. Using these bioinformatic analyses the DNA sequence encoding TmCad1-TBR was synthesized (GenScript, Inc.) and the peptide expressed in E. coli as described above for CR8-10 of the western corn rootworm cadherin.

### Example 6

### Cloning and Expression of the CRY3Bb Gene

The Cry3Bb coding region was cloned by PCR using total DNA extracted from the Bt biological insecticide Raven (Ecogen, Inc. Langhorne, Pa.) as template with primers Cry3Bb/FWD (CAGGTCTAGAGTTATGTATTATGATAAGAATGGG) and Cry3Bb/REV (TAAACTCGAGTTACAATTGTACTGGGATAAATTC). The PCR amplified cry3Bb gene was cloned into pGEM-T Easy vector (Promega, Madison, Wis.), and then subcloned between the Xba I and XhoI sites of the pET30a(+). The clone called Cry3Bb/pET was transformed into E. coli strain BL21-CodonPlus (DE3)/pRIL (Stratagene, LaJolla, Calif.). The coding sequence and clone orientation were confirmed by sequencing. The expression and purification protocol for the Cry3Bb protein inclusion bodies was as described above for CR8-10 peptide.

### Example 7

### Cloning of the CRY8Ca Gene

The full-length cry8Ca coding region was cloned by PCR using total DNA extracted from Bt japonensis strain BuiBui with primers Cry8Ca/FWD and Cry8Ca/REV according to the nucleotide sequence deposited in GenBan with accession number Q45706. The PCR amplified cry8Ca gene was cloned into pGEM-T-easy vector (Promega, Madison, Wis.), and then subcloned between the Xba I and XhoI sites of the pET30a(+). The clone called Cry3Bb/pET was transformed into E. coli strain BL21-CodonPlus (DE3)/pRIL (Stratagene, LaJolla, Calif.). The coding sequence and clone orientation were confirmed by sequencing. The expression and purification protocol for the Cry3Bb protein inclusion bodies was as described above for DvCad1-CR8-10 peptide.

### Example 8

### Results

The DvCad1-CR8-10 region of WCRW cadherin (Sayed et al. 2007a) was over-expressed in E. coli and tested for the ability to enhance Bt tenebrionis toxicity to A. diaperinus larvae. The DvCad1-CR8-10 region is homologous to toxin-enhancing regions from M. sexta and A. gambiae cadherins and contains a predicted toxin binding region (Sayed et al. 2007). The native WCRW coding sequence was optimized for E. coli expression, and most of the CₚG sequences in the native cadherin sequence were removed to decrease potential DNA methylation in planta. The synthetic DvCad1-CR8-10 peptide of 377 amino acid residues has an initiation methionine, a C-terminal 6 histidine tag, and a molecular size of 42,814 Da. Inclusion bodies isolated from recombinant E. coli were composed of the expected 45-kDa protein, plus lesser amounts of two about 30-kDa peptides.

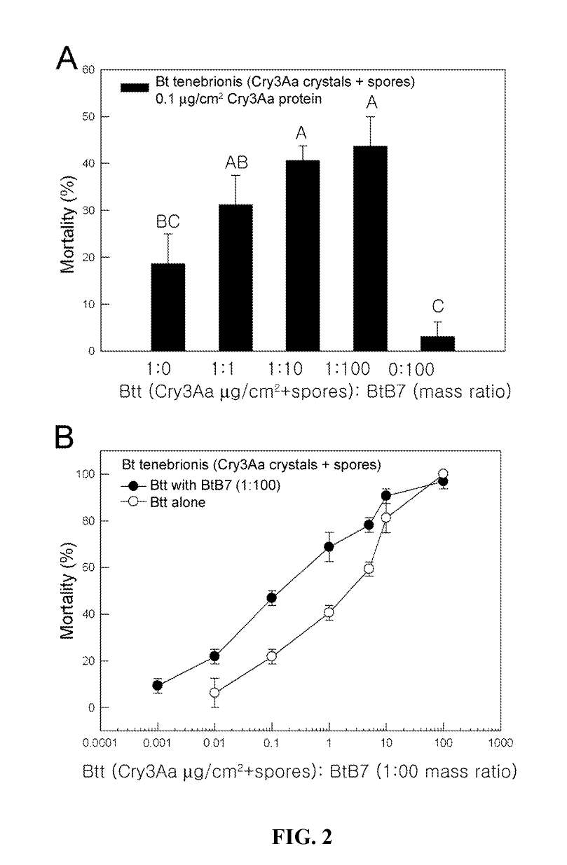

Suspensions of Bt tenebrionis alone and Bt tenebrionis with DvCad1-CR8-10 inclusions were applied to insect diet and fed to first instar A. diaperinus larvae. A low dose (0.1 μg/cm²) of Bt tenebrionis spore-crystal suspension caused about 20% larval mortality. To determine the extent that DvCad1-CR8-10 could enhance this low dose of toxin, we added increasing amounts of CR8-10 inclusions to the Btt spore+Cry3Aa crystal suspension. As seen in FIG. 2A the enhancement effect increased as ratios were increased from 1:1 (Cry protein:CR8-10) mass ratio to 1:10 and then 1:100 mass ratio. As shown in FIG. 2B the addition of CR8-10 inclusions at a 1:100 mass ratio of Btt Cry3Aa:CR8-10 to the Bt suspensions reduced the amount of Btt spores and crystals required to kill lesser mealworms.

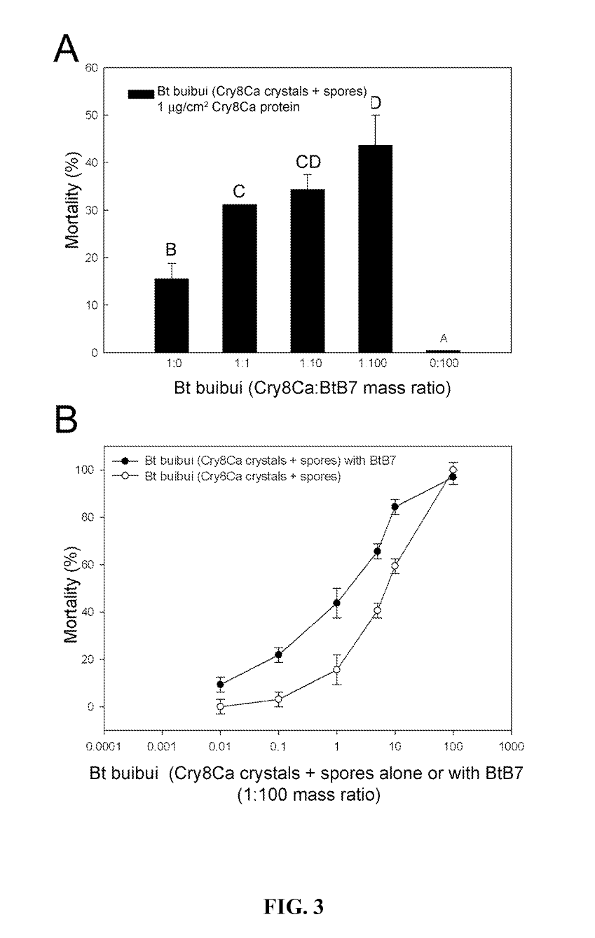

In a similar set of experiments the DvCad1-CR8-10 region of WCRW cadherin (Sayed et al. 2007) was tested for the ability to enhance Bt japonensis BuiBui toxicity to A. diaperinus larvae. Suspensions of Bt japonensis BuiBui spores+Cry8Ca crystals alone and the Bt BuiBui with DvCad1-CR8-10 inclusions were applied to insect diet and fed to first instar A. diaperinus larvae. As shown in FIG. 3A, an amount of Bt japonensis BuiBui equivalent to 1 μg/cm² of Bt BuiBui spore-crystal suspension caused about 15% larval mortality. To determine the extent that DvCad1-CR8-10 could enhance this dose of Bt japonensis BuiBui, we added increasing amounts of CR8-10 inclusions to the Bt japonensis buibui spore-Cry8Ca suspension and applied the mixture to the diet surface. As seen in FIG. 3A the enhancement effect was observed at a 1:1 (Bt BuiBui Cry8Ca:CR8-10) mass ratio with further mortality induced at 1:10 and 1:100 mass ratios. FIG. 3B shows the affects of adding DvCad1-CR-810 to increasing concentrations Bt japonensis BuiBui (1:100 Bt BuiBui Cry8Ca:CR8-10). At each Bt japonensis BuiBui concentration tested, increased mortality occurred with the addition of DvCad1-CR8-10.

These results show that both Bt tenebrionis and Bt japonensis BuiBui strains are insecticidal to A. diaperinus larvae and that a coleopteran-active BtB elicits a synergistic effect in lesser mealworm bioassays.

### Example 9

### Further Results

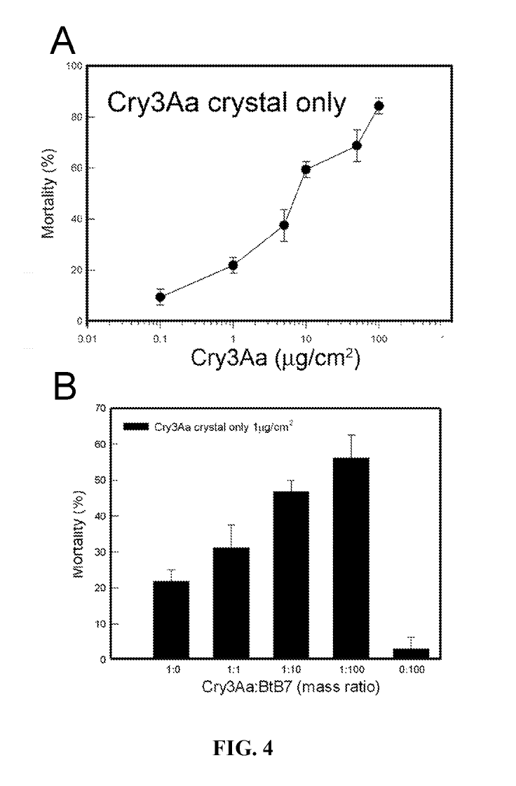

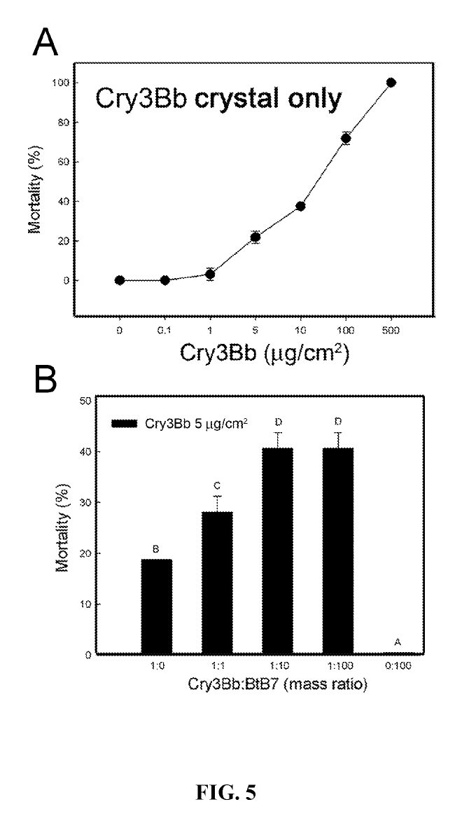

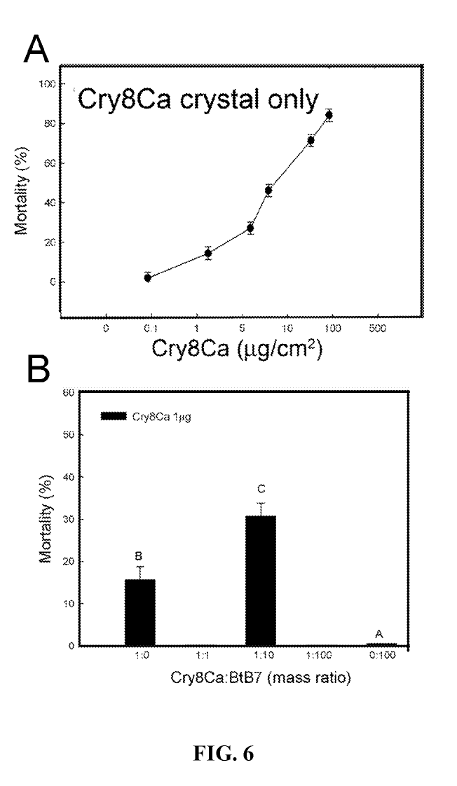

Cry3Aa, Cry3Bb and Cry8Ca crystals were tested alone and in combination with BtBooster DvCad1-CR8-10 peptide inclusions. The results of dose response bioassays using crystals alone are shown in FIG. 4A, FIG. 5A and FIG. 6A. Each Cry protein caused increased mortality of lesser mealworms with increasing Cry protein concentrations. A Cry protein concentration that caused about 20% mortality was chosen for further bioassays using various DvCad1-CR8-10 protein inclusions. The selected concentrations were 1 and 5 μg/cm2, respectively for Cry3Aa and Cry3Bb crystals. The addition of a 1:1 (Cry3:CR8-10) mass ratio caused a slight increase in larval mortality for both Cry3 crystals. As the ratio of (Cry3:CR8-10) increased additional mortality occurred. In preliminary bioassays, a 1:10 (Cry8Ca:CR8-10) mass ratio enhanced Cry8Ca toxicity to A. diaperinus larvae.

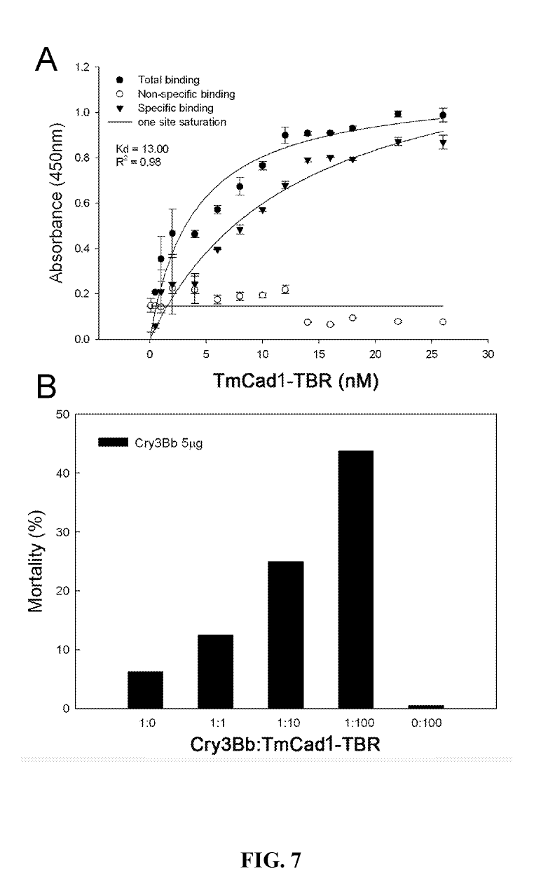

We tested the possibility that TmCad1-TBR binds a coleopteran-active Cry toxins using a microplate binding assay described previously (Zhang et al. 2008). As shown in FIG. 5B TmCad1-TBR bound Cry3Bb with a high 13 nM affinity. Recently, a nearly identical cadherin peptide from T. molitor cadherin was shown to bind Cry3Aa. TmCad1-TBR also enhances Cry3Bb toxicity to A. diaperinus larvae (FIG. 7A).

Using bioassays with lesser mealworms, we established that TmCad1-TBR enhances Cry3Bb toxicity to lesser mealworms. To determine the extent TmCad1-TBR could enhance Cry3Bb, we added increasing amounts of TmCad1-TBR inclusions to aliquots of a Cry3Bb crystal suspension and applied the aliquots to diet surface. As seen in FIG. 7A the enhancement effect was observed at a 1:1 (Cry3Bb:TmCad1-TBR) mass ratio with further mortality of lesser mealworms induced at 1:10 and 1:100 mass ratios. As shown by the 0:100 (Cry3Bb:TmCad1-TBR) suspension, TmCad1-TBr alone did not kill lesser mealworms.

### REFERENCES

Abdullah, M. A., Moussa, S., Taylor, M. D., Adang, M. J., 2009. Manduca sexta (Lepidoptera: Sphingidae) cadherin fragments functions as synergists for Cry1A and Cry1C Bacillus thuringiensis toxins against noctuid moths Helicoverpa zea, Agrotis ipsilon, and Spodoptera exigua. Pest Management Science. DOI 10.1002/ps.1798
Alm, S. R., Villani, M. G., Yeh, T., Shutter, R., 1997. Bacillus thuringiensis serovar japonensis strain BuiBui for control of Japanese and Oriental beetle larvae (Coleoptera: Scarabaeidae). Appl. Entomol. Zool. 32, 477-484.
Altschul, S. F., Gish, W., Miller, W., Myers, E. W., Lipman, D. J., 1990. Basic local alignment search tool. J. Mol. Biol. 215, 403-410.
Altschul, S. F., Madden, T. L., Schaffer, A. A., Zhang, J., Zhang, Z., Miller, W., Lipman, D. J., 1997. Gapped BLAST and PSI-BLAST: a new generation of protein database search programs. Nucleic Acids Res. 25, 3389-3402.
Bates, C., Hiett, K. L., Stern, N. J., 2004. Relationship of Campylobacter isolated from poultry and from darkling beetles in New Zealand. Avian Dis. 48, 138-147.
Bauer, L. S., 1990. Response of the cottonwood leaf beetle (Coleoptera: Chrysomelidae) to Bacillus thuringiensis var. san diego. Environ. Entomol. 19, 428-431.
Belfiore, C. J., Vadlamudi, R. K., Osman, Y. A., Bulla, L. A., Jr., 1994. A specific binding protein from Tenebrio molitor for the insecticidal toxin of Bacillus thuringiensis subsp. tenebrionis. Biochem. Biophys. Res. Commun 200, 359-364.
Beltz, G. A., Jacobs, K. A., Eickbush, T. H., Cherbas, P. T., Kafatos, F. C., 1983. Isolation of multigene families and determination of homologies by filter hybridization methods. Methods Enzymol. 100, 266-285.
Bradford, M., 1976. A rapid and sensitive method for the quantitation of microgram quantities of protein utilizing the principle of protein-dye binding. Anal. Biochem. 72, 248-254.
Brownbridge, M., Margalit, J., 1986. New Bacillus thuringiensis strains isolated in Israel are highly toxic to mosquito larvae. J. Invertebr. Pathol. 48, 216-222.
Calibeo-Hayes, D., Denning, S. S., Stringham, S. M., Watson, D. W., 2005. Lesser mealworm (Coleoptera: Tenebrionidae) emergence after mechanical incorporation of poultry litter into field soils. J. Econ. Entomol. 98, 229-235.
Carroll, J., Convents, D., Van Damme, J., Boets, A., Van Rie, J., Ellar, D. J., 1997. Intramolecular proteolytic cleavage of Bacillus thuringiensis Cry3A delta-endotoxin may facilitate its coleopteran toxicity. J. Invertbr. Path. 70, 41-49.
Chen, J., Hua, G., Jurat-Fuentes, J. L., Abdullah, M. A., Adang, M. J., 2007. Synergism of Bacillus thuringiensis toxins by a fragment of a toxin-binding cadherin. Proc. Natl. Acad. Sci. USA 104, 13901-13906.
Donovan, W. P., Engleman, J. T., Donovan, J. C., Baum, J. A., Bunkers, G. J., Chi, D. J., Clinton, W. P., English, L., Heck, G. R., Ilagan, O. M., Krasomil-Osterfeld, K. C., Pitkin, J. W., Roberts, J. K., Walters, M. R., 2006. Discovery and characterization of Sip1A: a novel secreted protein from Bacillus thuringiensis with activity against coleopteran larvae. Appl. Microbiol. Biotech. 72, 713-719.
Donovan, W. P., Rupar, M. J., Slaney, A. C., Malvar, T., Gawron-Burke, C., Johnson, T. B., 1992. Characterization of two genes encoding Bacillus thuringiensis insecticidal crystal proteins toxic to Coleroptera species. Appl. Environ. Microbiol. 58, 3921-3927.
Fabrick, J., Oppert, C., Lorenzen, M. D., Morris, K., Oppert, B., Jurat-Fuentes, J. L., 2009. A novel Tenebrio molitor cadherin is a functional receptor for Bacillus thuringiensis Cry3Aa toxin. J Biol. Chem. 284, 18401-18410.
Galitsky, N., Cody, V., Wojtczak, A., Ghosh, D., Luft, J. R., Pangborn, W., English, L., 2001. Structure of the insecticidal bacterial delta-endotoxin Cry3 Bb 1 of Bacillus thuringiensis. Acta Crystallographica Section D-Biological Crystallography 57, 1101-1109.
Gelernter, W., 2004. The rise and fall of Bacillus thuringiensis tenebrionis. Phytoparasitica 32, 321324.

Herrnstadt, C., Soares, G., Wilcox, E. R., Edwards, D. L., 1986. A new strain of Bacillus thuringiensis with activity against coleopteran insects. Bio/Technology 4, 305-308.
Hua, G., Jurat-Fuentes, J. L., Adang, M. J., 2004. Bt-R1a extracellular cadherin repeat 12 mediates Bacillus thuringiensis Cry1Ab binding and toxicity. J. Biol. Chem. 279, 28051-28056.
Hua, G., Zhang, R., Abdullah, M. A., Adang, M. J., 2008. Anopheles gambiae cadherin AgCad1 binds the Cry4Ba toxin of Bacillus thuringiensis israelensis and a fragment of AgCad1 synergizes toxicity. Biochemistry 47, 5101-5110.
Johnson, T. B., Slaney, A. C., Donovan, W. P., Rupar, M. J., 1993. Insecticidal activity of Eg4961, a novel strain of Bacillus thuringiensis toxic to larvae and adults of southern corn-rootworm (Coleoptera, Chrysomelidae) and Colorado potato beetle (Coleoptera, Chrysomelidae). J. Econ. Entomol. 86, 330-333.
Karlin, S., Altschul, S. F., 1990. Methods for assessing the statistical significance of molecular sequence features by using general scoring schemes. Proc. Natl. Acad. Sci. USA 87, 2264-2268.
Karlin, S., Altschul, S. F., 1993. Applications and statistics for multiple high-scoring segments in molecular sequences. Proc. Natl. Acad. Sci. USA 90, 5873-5877.
Keller, G. H., Manak, M. M., 1987. DNA Probes. In: Stockton Press, New York, N.Y., pp. 169-170
Li, J., Carroll, J., Ellar, D. J., 1991. Crystal structure of insecticidal δ-endotoxin from Bacillus thuringiensis at 2.5 A resolution. Nature 353, 815-821.
Loseva, O., Ibrahim, M., Candas, M., Koller, C. N., Bauer, L. S., Bulla, J., L. A., 2002. Changes in protease activity and Cry3Aa toxin binding in the Colorado potato beetle L implications for insect resistance to Bacillus thuringiensis toxins. Insect Biochem. Mol. Biol. 32, 566-577.
Martinez-Ramirez, A. C., Real, M. D., 1996. Proteolytic processing of Bacillus thuringiensis CryIIIA toxin and specific binding to brush-border membrane vesicles of Leptinotarsa decemlineata (Colorado Potato Beetle). Pesticide Biochem. Physiol. 54, 115-122.
McAllister, J. C., Steelman, C. D., Skeeles, J. K., 1994. Reservoir competence of the lesser mealworm (Coleoptera: Tenebrionidae) for Salmonella typhimurium (Eubacteriales: Enterobacteriaceae). J. Med. Entomol. 31, 369-372.
Miller, R. W., 1990. Use of ivermectin to control the lesser mealworm (Coleoptera: Tenebrionidae) in a simulated poultry broiler house. Poult Sci 69, 1281-1284.
Ochoa-Campuzano, C., Real, M. D., Martinez-Ramirez, A. C., Bravo, A., Rausell, C., 2007. An ADAM metalloprotease is a Cry3Aa Bacillus thuringiensis toxin receptor. Biochem. Biophys. Res. Commun 362, 437-442.
Ogiwara, K., Hori, H., Minami, M., Takeuchi, K., Sato, R., Ohba, M., Iwahana, H., 1995. Nucleotide sequence of the gene encoding novel delta-endotoxin from Bacillus thuringiensis serovar japonensis strain Buibui specific to scarabaeid beetles. Curr. Microbiol 30, 227-235.
Ohba, M., Iwahana, H., Asano, S., Suzuki, N., Sato, R., Hori, H., 1992. A unique isolate of Bacillus thuringiensis serovar japonensis with a high larvicidal activity specific for scarabaeid beetles. Lett. Appl. Microbiol. 14, 54-57.
Park, Y., Abdullah, M. A., Taylor, M. D., Rahman, K., Adang, M. J., 2009. Enhancement of Bacillus thuringiensis Cry3Aa and Cry3Bb toxicities to coleopteran larvae by a toxin-binding fragment of an insect cadherin. Appl. Environ. Microbiol. 75, 3086-3092.
Payne, J., Fernandez-Cornejo, J., Daberkow, S., 2003. Factors affecting the likelyhood of corn rootworm Bt seed adoption. AgBioForum 6, 79-86.
Salin, C., Delettre, Y. R., Vernon, P., 2003. Controlling the mealworm Alphitobius diaperinus (Coleoptera: Tenebrionidae) in broiler and turkey houses: field trials with a combined insecticide treatment: insect growth regulator and pyrethroid. J. Econ. Entomol. 96, 126-130.
Sambrook, J., MacCallum, P., 2001. Molecular Cloning: A Laboratory Manual. Cold Spring Harbor Laboratories Press, Woodbury, N.Y.
Sato, R., Takeuchi, K., Ogiwara, K., Minami, M., Kaji, Y., Suzuki, N., Hori, H., Asano, S., Ohba, M., Iwahana, H., 1994. Cloning, heterologous expression, and localization of a novel crystal protein gene from Bacillus thuringiensis serovar japonensis strain buibui toxic to scarabaeid insects. Curr. Microbiol. 28, 15-19.
Sayed, A., Nekl, E. R., Siqueira, H. A., Wang, H. C., Ffrench-Constant, R. H., Bagley, M., Siegfried, B. D., 2007a. A novel cadherin-like gene from western corn rootworm, Diabrotica virgifera virgifera (Coleoptera: Chrysomelidae), larval midgut tissue. Insect Mol. Biol. 16, 591-600.
Sayed, A., Nekl, E. R., Siqueira, H. A. A., Wang, H.-C., ffrench-Constant, R. H., Bagley, M., Siegfried, B. D., 2007b. A novel cadherin-like gene from western corn rootworm, Diabrotica virgifera virgifera (Coleoptera: Chrysomelidae), larval midgut tissue. Insect Mol. Biol. 16, 591-600.Skov, M. N., Spencer, A. G., Hald, B., Petersen, L., Nauerby, B., Carstensen, B., Madsen, M., 2004. The role of litter beetles as potential reservoir for Salmonella enterica and thermophilic Campylobacter spp. between broiler flocks. Avian Dis. 48, 9-18.
Slaney, A. C., Loidl Robbins, H., English, L., 1992. Mode of action of Bacillus thuringiensis toxin CryIIIA: An analysis of toxicity in Leptinotarsa decemlineata (Say) and Diabrotica undecimpunctata howardi barber. Insect Biochem. Mol. Biol. 22, 9-18.
Soberon, M., Pardo-Lopez, L., Lopez, I., Gomez, I., Tabashnik, B. E., Bravo, A., 2007. Engineering modified Bt toxins to counter insect resistance. Science 318, 1640-1642.
Vaughn, T., Cavato, T., Brar, G., Coombe, T., DeGooyer, T., Ford, S., Groth, M., Howe, A., Johnson, S., Kolacz, K., Pilcher, C., Purcell, J., Romano, C., English, L., Pershing, J., 2005. A method of controlling corn rootworm feeding using a Bacillus thuringiensis protein expressed in maize. Crop Science 45, 931-938.
Walters, F. S., Stacy, C. M., Lee, M. K., Palekar, N., Chen, J. S., 2008. An engineered chymotrypsin/cathepsin G site in domain I renders Bacillus thuringiensis Cry3A active against Western corn rootworm larvae. Appl. Environ. Microbiol. 74, 367-374.
Wu, S. J., Dean, D. H., 1996. Functional significance of loops in the receptor binding domain of Bacillus thuringiensis CryIIIA delta-endotoxin. J. Mol. Biol. 255, 628-640.
Wu, S. J., Koller, C. N., Miller, D. L., Bauer, L. S., Dean, D. H., 2000. Enhanced toxicity of Bacillus thuringiensis Cry3A delta-endotoxin in coleopterans by mutagenesis in a receptor binding loop. FEBS Lett. 473, 227-232.
Xie, R., Zhuang, M., Ross, L. S., Gomez, I., Oltean, D. I., Bravo, A., Soberon, M., Gill, S. S., 2005. Single amino acid mutations in the cadherin receptor from Heliothis virescens affect its toxin binding ability to Cry1A toxins. J. Biol. Chem. 280, 8416-8425.
Zhang, R., Hua, G., Andacht, T. M., Adang, M. J., 2008. A 106-kDa aminopeptidase is a putative receptor for Bacillus thuringiensis Cry11Ba toxin in the mosquito Anopheles gambiae. Biochem. 47, 11263-11272.

1. A method of inhibiting an insect, which includes a larva, of the genus Alphitobius wherein said method comprises providing a polypeptide and a Bacillus thuringiensis Cry protein to said insect for ingestion, wherein
said Cry protein is selected from the group consisting of Cry3 and Cry8,
said polypeptide comprises a segment that binds said Cry protein, and
said segment is at least 85% identical with a Cry binding fragment of a midgut cadherin ectodomain from a coleopteran insect.

2. The method of claim 1 wherein said Cry protein is selected from the group consisting of Cry3A, Cry3B, and Cry8C.

3. The method of claim 1 wherein said Cry protein is selected from the group consisting of Cry3Aa, Cry3Bb, and Cry8Ca.

4. The method of claim 1 wherein said polypeptide is at least 85% identical with SEQ ID NO:2 (Dv CR8-10; BTB7) or SEQ ID NO:4 (Tmcad).

5. A method of inhibiting a coleopteran insect, which includes a larva, wherein said method comprises providing a polypeptide and a Bacillus thuringiensis Cry protein to said insect for ingestion, wherein
said Cry protein is selected from the group consisting of Cry3 and Cry8,
said polypeptide comprises a segment that binds said Cry protein, and
said segment is at least 85% identical with SEQ ID NO:2 (Dv CR8-10) or SEQ ID NO:4.

6. The method of claim 1 wherein said polypeptide is produced by a plant.

7. The method of claim 1 wherein said Cry protein is produced by a plant.

8. The method of claim 1 wherein said polypeptide and said Cry protein are produced by a plant.

9. A method of claim 6 wherein powder is produced from grinding said plant or parts therefrom, said powder comprises said polypeptide and/or said Cry, and said powder is applied in a chicken house.

10. A method of claim 1, wherein said Cry protein is produced by bacteria.

11. The method of claim 10 wherein said bacteria is selected from the group consisting of Pseudomonas fluorescens, Bacillus thurningiensis tenebrionis, and Bacillus thurningiensis japonensis BuiBui.

12. A method of inhibiting an Alphitobius insect, which includes a larva, wherein said method comprises providing a Bacillus thuringiensis Cry protein, selected from the group consisting of Cry3Aa and Cry8C, to said insect for ingestion.

13. The method of claim 12 wherein said protein is applied in a chicken house and/or to chicken feed.

14. A method of claim 7 wherein powder is produced from grinding said plant or parts therefrom, said powder comprises said polypeptide and/or said Cry, and said powder is applied in a chicken house.

15. A method of claim 8 wherein powder is produced from grinding said plant or parts therefrom, said powder comprises said polypeptide and/or said Cry, and said powder is applied in a chicken house.

16. A method of claim 5, wherein said Cry protein is produced by bacteria.


SEQUENCE LISTING (4 sequences)

SEQ ID NO: 1 - DNA, 1134 bp, Diabrotica virgifera
atggctgttcttatgactaaagacctgcagtgctctgaaaacctgaacaaggatggtgaagtaggtgagggcatcattggtgaagacattgatgatggtgacaacgctaaaattgacttctctgttttgtctattgtagataaggaaactaagaacgacatccaggaatcctttaacatctccaaaattgattctgattatgtgctcaacgacactctgaagaaagtacacctgattgcttttgaagatctgaaaggtaaatatggaacctatgaagtaaccctccacatgcatgatgaaggtgacccaatgcagactactgacccagatccaaccctgaccctgaccattgagaaatggaactaccagacccctagcattattttcccagaaaacgaccagacctacattgtgctgagcgaccagcagcctggtcagccactggcactgtttaacaacactggtacatccaacactctgccagacttctcagctactgatggtgagactaaagactatagcaaatgggatgtaaagttcagctacacccagaccaactatgaagatgacaagatctttgttattgatcacatccagccatgcgtttcccagcttcaggttagcaaacacttcaactctgacctggttcgctccaagaaatacaaactgactatcactgcttctgtgaaggatggtgctgaacaggaaggtgaggctggctactctacttctgcaaacatctctattgttttcctgaacaacgatgctcagccaatctttcagaactctgactggtctgtttcctttgttgagttcaacaccactcagccagcaaaaccactggaagaacaggcagaatatgaaaacaccaagggtggcctgccgatctattaccatttctactctgaaaaccagaccctgtccaaatactttgaggttgatgagacttctggtgacctgtctgttattggtaacctgacttatgactatgaccaggacatcagctttcacattgttgcttccaacgattctcaggtacgcatgctggacccacgctcttctctgaacgtaactgtaaacttcctgccacgtaaccgtcgtgccccacagtggcaccaccaccaccaccactaa

SEQ ID NO: 2 - protein, 377 aa, Diabrotica virgifera
MAVLMTKDLQCSENLNKDGEVGEGIIGEDIDDGDNAKIDFSVLSIVDKETKNDIQESFNISKIDSDYVLNDTLKKVHLIAFEDLKGKYGTYEVTLHMHDEGDPMQTTDPDPTLTLTIEKWNYQTPSIIFPENDQTYIVLSDQQPGQPLALFNNTGTSNTLPDFSATDGETKDYSKWDVKFSYTQTNYEDDKIFVIDHIQPCVSQLQVSKHFNSDLVRSKKYKLTITASVKDGAEQEGEAGYSTSANISIVFLNNDAQPIFQNSDWSVSFVEFNTTQPAKPLEEQAEYENTKGGLPIYYHFYSENQTLSKYFEVDETSGDLSVIGNLTYDYDQDISFHIVASNDSQVRMLDPRSSLNVTVNFLPRNRRAPQWHHHHHH

SEQ ID NO: 3 - DNA, 627 bp, Tenebrio molitor
atgaaacagtggtatcagcgtcgtgttgccatcaccgcaggtaaagacaccacctctaaagacaaactgcagtacaacatcgacaacatcaccccgtccaacctggacctggacatcaaatccgcgttcactatgaacactcagagcggtgatatcaccatcaactttgaggttaaagactctatggaaggctacttcaccctggacctgtccgtacaggatgaagaaccggaaaaccacaaagctgacgcaaccctgaaaatctacattgtaacctctaagaacactgtagttttccgcttcgaaaacgaccaggaaactgttagcgacaaagcgggggacatcaaatctgtactcgacgaagaattccagtacgaaaccaaagttgaagccccgacaggtaacaccactgacggtacgccgctgacccgtagcccggttttcttcctgaacctcaacaccaatgaaccggttgacgctaccgagatcctgaagaaagttactaacgtagatgttttccagcgtctgaagaacaacttctctaaagttggcctggttctgctgtccttcgactctagctctgagactaacgaaaacctggaggcacatcatcatcatcatcattaa

SEQ ID NO: 4 - protein, 208 aa, Tenebrio molitor
MKQWYQRRVAITAGKDTTSKDKLQYNIDNITPSNLDLDIKSAFTMNTQSGDITINFEVKDSMEGYFTLDLSVQDEEPENHKADATLKIYIVTSKNTVVFRFENDQETVSDKAGDIKSVLDEEFQYETKVEAPTGNTTDGTPLTRSPVFFLNLNTNEPVDATEILKKVTNVDVFQRLKNNFSKVGLVLLSFDSSSETNENLEAHHHHHH